(19) United States
(12) Patent Application Publication
(10) Pub. No.: US 2022/0108287 A1
(43) Pub. Date: Apr. 7, 2022

(54) SMART CARD WITH REVERSE PAYMENT TECHNOLOGY

(71) Applicant: Bank of America Corporation, Charlotte, NC (US)

(72) Inventor: Saurabh Gupta, New Delhi (IN)

(21) Appl. No.: 17/060,114

(22) Filed: Oct. 1, 2020

(51) Int. Cl. G06Q 20/10; G06Q 20/34; G06Q 40/02; G06Q 20/40; G06Q 20/02; H04L 29/06; G06K 19/07

(52) U.S. Cl. CPC G06Q 20/108; G06Q 20/341; G06Q 20/352; G06Q 40/02; G06K 19/0704; G06Q 20/027; H04L 63/0853; G06K 19/0723; G06Q 20/409

(57) ABSTRACT

Apparatus and methods are provided for a smart card which enables users to securely complete online transactions without entering any sensitive transaction information into a third-party system. The smart card may include a microprocessor and wireless interface. The wireless interface may provide wireless communication capabilities and the ability to initiate online payments based on information captured by the touch-sensitive screen. The wireless interface may receive communications from a merchant or issuer bank requesting payment. The microprocessor may be configured to download contact names and associated contact phone numbers from a cloud computing account. The user may select a contact name. The microprocessor may be configured to resolve a contact bank account and contact smart card associated with a contact phone number. The microprocessor may be configured to send a payment request to the contact bank account and contact smart card.

### FIELD OF TECHNOLOGY

Aspects of the disclosure relate to a smart payment card with enhanced communication features.

### BACKGROUND OF THE DISCLOSURE

When conducting online transactions and payments, users typically enter credit card information or other sensitive transaction information into a web browser or mobile application. However, doing so increases a risk that the sensitive transaction information will be compromised. For example, security associated with the web browser may be substandard or the security of another network system utilized by a mobile application may be exposed. These potential security flaws associated with third-party systems that transmit and capture sensitive transaction information may increase the exposure risk.

In addition to security breaches of even reputable third-party systems, there are fraudulent actors who design illegitimate systems which attempt to induce users to enter sensitive transaction information into legitimate-looking webpages. These illegitimate systems are typically designed to appear as a reputable system or webpage, and thereby induce the user to enter sensitive transaction information. The illegitimate system may then expose the captured sensitive transaction information for self-serving, fraudulent, pecuniary gain.

Recently, use of digital wallets has proliferated. These digital wallets are typically associated with more reliable security measures than prior systems. However, even use of a digital wallet does not fully address the challenges in securing sensitive transaction information. For example, when using digital wallets, sensitive transaction information may still be captured using third-party applications that may track use and content of the sensitive transaction information. By increasing the number of parties that handle the sensitive transaction information, there is an associated increase in risk that the sensitive transaction information will be inadvertently disclosed.

It would be desirable to provide more secure apparatus and methods for users to make online payments without providing sensitive transaction information to any third-party system. In addition to reducing the exposure risk of sensitive transaction information, such apparatus and methods may improve the user experience when making an online payment.

It would also be desirable to provide more secure apparatus and methods for users to request payment from other smart card accounts and complete the payment transaction.

### SUMMARY OF THE DISCLOSURE

Aspects of the disclosure relate to a smart card with self-contained transaction architecture for increasing transactional efficiency and security. The smart card may include a microprocessor, a touch-sensitive screen, a power source for the microprocessor and the touch-sensitive screen, a wireless interface configured to provide wireless communication to a payment gateway, and a non-transitory memory storing computer-executable instructions.

The instructions, when run on the microprocessor, may be configured to connect to a cloud computing account using the wireless interface.

The instructions when run on the microprocessor may be further configured to download contacts comprising a plurality of contact names and associated contact phone numbers from the cloud computing account.

The instructions when run on the microprocessor may be configured to display on the touch-sensitive screen a selectable list of contact names downloaded from the cloud computing account.

The instructions when run on the microprocessor may be configured to receive a selection of a contact name from the plurality of contact names, via the touch-sensitive screen.

The instructions when run on the microprocessor may be configured to use the contact phone number associated with the selected contact name to identify a contact bank account and a contact smart card associated with the contact bank account.

The instructions when run on the microprocessor may be configured to transmit instructions to request a payment amount from the contact bank account and the contact smart card.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative system architecture in accordance with principles of the disclosure;

FIG. 3 shows illustrative system architecture in accordance with principles of the disclosure; and

FIG. 4A-4B shows illustrative apparatus in accordance with the principles of the disclosure.

FIG. 5A-5B shows illustrative apparatus in accordance with the principles of the disclosure.

### DETAILED DESCRIPTION

A smart card with self-contained transaction architecture is provided. The card may increase transactional efficiency and security. For example, efficiency may be increased by eliminating the need to use a device external to the card for executing transactions. Security may be increased by providing a system with dedicated transactional hardware, software, and/or communication channels. Such a system may be associated with a decreased risk of infection with malware, spyware, or other security risk factors.

The smart card may be part of a system for increasing transactional efficiency and security. The card may include a microprocessor, a touch-sensitive screen, a power source for the microprocessor and the touch-sensitive screen, a wireless interface configured to provide wireless communication to a payment gateway, and a non-transitory memory storing computer-executable instructions. The instructions, when run on the microprocessor, may be configured to perform some or all of the disclosed features of the card.

The smart card may include metal and/or plastic. The card may have dimensions that conform to the ISO/IEC 7810 ID-1 standard. The dimensions may, in some embodiments, be no greater than 86 millimeters×54 millimeters×0.8 millimeters.

In some embodiments of the smart card, the wireless interface may include a wireless network interface card (“NIC”).

In some embodiments, the power source may be rechargeable. The power source may recharge via solar energy, inductive charging, a charging port, and/or any other suitable charging mechanism.

In some embodiments, the smart card may include a payment interface to resolve different payment options to different secure payment gateways.

In some embodiments, the smart card may include a phone to bank resolver that associates contact phone numbers with accounts at financial institutions or other smart card issuers.

In some embodiments, the smart card may include a reverse payment initiator that may be configured to request a payment amount from a contact bank account and contact smart card and send payment instructions to a payment gateway.

In some embodiments, the microprocessor, the power source, the wireless interface, the payment interface, and/or the memory may be embedded in the smart card. The touch-sensitive screen may be affixed to the smart card and may be exposed on a surface of the smart card.

The smart card may include hardware and associated integrated circuitry for users to complete online payments without entering sensitive transaction information into a third-party system such as a web browser or other software applications. The smart card may include a touch-sensitive screen. The smart card may include a virtual keypad. The user may depress keys on the keypad or use the touch-sensitive screen to enter information directly into the smart card.

The smart card may include a microprocessor and a Network Interface Card (“NIC”). The microprocessor and associated NIC may enable the card to establish a communication channel. Over the secure communication channel, the smart card may interact directly with a secure system for making a payment. The secure system may be operated by an issuer of the smart card. The microprocessor may have a thickness that is not greater than 0.25 millimeters (“mm”). The microprocessor may control overall operation of the smart card and its associated components.

The smart card may include various other hardware components. Such components may include a battery, a speaker, and antenna(s). The smart card may include RAM, ROM, an input/output (“I/O”) module and a non-transitory or non-volatile memory.

The I/O module may include a microphone which may accept user provided input. The I/O module may include one or more of a speaker for providing audio output and a display for providing textual, audiovisual and/or graphical output.

Software may be stored within the non-transitory memory and/or other storage media. Software may provide instructions, that when executed by the microprocessor, enable the smart card to perform various functions. For example, software may include an operating system, application programs, web browser and a database. Alternatively, some or all of computer executable instructions of the smart card may be embodied in hardware or firmware components of the smart card.

Application programs, which may be used by the smart card, may include computer executable instructions for invoking user functionality related to communication, authentication services, and voice input and speech recognition applications. Application programs may utilize one or more algorithms that encrypt information, process received executable instructions, interact with an issuer or acquirer bank systems, perform power management routines or other suitable tasks.

The smart card may include a pressure sensitive button. The pressure sensitive button may have a thickness that is not greater than 0.8 mm. A user may actuate the pressure sensitive to power on or off one or more components of the smart card. For example, actuating the pressure sensitive button may activate the microprocessor, NIC, touch-sensitive screen of the smart card.

The smart card may operate in a networked environment. The smart card may support establishing communication channels with one or more issuer or acquirer bank systems. The smart card may connect to a local area network (“LAN”), a wide area network (“WAN”) a cellular network or any suitable communication network. When used in a LAN networking environment, the smart card may be connected to the LAN through a network interface or adapter. The NIC may include the network interface or adapter.

When used in a WAN networking environment, the smart card may include a modem or other means for establishing communications over a WAN, such as the Internet. The NIC may include the modem. It will be appreciated that the existence of any of various well-known protocols such as TCP/IP, Ethernet, FTP, HTTP and the like is presumed.

The smart card may be operational with numerous other general purpose or special purpose computing system environments or configurations. Examples of well-known computing systems, environments, and/or configurations that may be suitable for use with the invention include, but are not limited to, other smart cards, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The smart card may utilize computer-executable instructions, such as program modules, being executed by a computer. Generally, program modules include routines, programs, objects, components, data structures, etc. that perform particular tasks or implement particular abstract data types. The smart card may be operational with distributed computing environments where tasks are performed by remote processing devices that are linked through a communications network. In a distributed computing environment, program modules may be located in both local and remote computer storage media including memory storage devices.

The smart card may include one or more batteries. A battery of the smart card may be flexible. The battery may be a power source for electronic hardware components of the smart card. For example, the battery may supply power to a touch-sensitive screen, NIC and microprocessor. The battery may have a thickness that is not greater than 0.5 mm.

In some embodiments, the smart card may include an electrical contact. The battery may be recharged via an electrical contact when the smart card is inserted into an Automated Teller Machine (“ATM”). An electrical contact may be constructed using any suitable material that conducts or transfers electricity. The smart card may include a plurality of electrical contacts. An electrical contact may be accessible on any suitable face of a housing of the smart card. The contact may be utilized to transfer electrical charge to the rechargeable battery when the smart card is inserted into a card reader of the ATM.

In some embodiments, the smart card's power source may include high frequency signals received from an ATM or other network node. The smart card may be configured to utilize received high frequency signals to recharge the battery or provide power to other hardware components of the smart card. The high frequency signals may conform to a standardized near field communication (NFC) communication standard.

Illustrative NFC protocols include European Computer Manufacturers Association Document Nos. 340 and 352 and International Organization for Standardization Document Nos. 18092 and 21481. All these standards are hereby incorporated by reference herein in their entireties.

The smart card may include a housing. The housing may provide a protective layer for internal components of the smart card. The housing may be flexible. The housing may be constructed from plastic or other suitable materials. The housing may define a form factor of the smart card. The microprocessor and other components of the smart card may be embedded in and protected by the housing. The smart card may include wireless interface embedded in the housing. The wireless interface may include a NIC. The smart card may include a touch-sensitive screen on an outside surface of the housing.

The housing and the touch-sensitive screen collectively may have a thickness that is not greater than 0.8 millimeters (“mm”) and a surface area that is not greater than 86 mm×54 mm. Such a compact form factor may allow the smart card to be inserted into traditional card readers and function as a typical debit or credit card.

For example, the user may use the smart card to access an ATM and withdraw cash. The user may also use the smart card to make a purchase at a traditional brick and mortar merchant location. The user may pay for such a purchase using a conventional point-of-sale (“POS”) terminal at the brick and mortar location. When the smart card is inserted into card reader of an ATM or POS terminal a battery of the smart card may be recharged.

The smart card may include a touch-sensitive screen. The touch-sensitive screen may capture finger motions. The finger motions may include payment information entered by a user of the smart card. The microprocessor may capture the finger motions entered using the touch-sensitive screen.

The smart card may include specialized software (executable by the microprocessor) for automatic conversion of finger motions as they are input by the user on the touch-sensitive screen.

The touch-sensitive screen may utilize resistive touch technology to detect user touch points. Screens constructed using resistive touch technology include an upper layer (which is touched by the user) spaced apart from a bottom layer. When the user touches the screen, the upper layer contacts the bottom layer, generating an electrical signal. Screens constructed using resistive touch technology only require the application of pressure and do not require application of heat or electrical charge to detect a touch point. Resistive-touch technology is also relatively less expensive than other touch sensing technologies.

The touch-sensitive screen may utilize capacitive touch technology to detect user touch points. Screens constructed using capacitive touch technology may identify where a user touches based on detecting an electrical disturbance created when the user touches the screen. The human body is an electronical conductor and, contact with another conducting surface such as the surface of a touch-sensitive screen, typically generates a detectable electrical disturbance. Capacitive touch technology detects the electrical disturbance and determines where on the screen the user touched.

The touch-sensitive screen may utilize any suitable touch detection technology such as surface acoustic wave, optical imaging, infrared acrylic projection or acoustic pulse recognition technologies.

The smart card may include a touch-sensing controller for detecting a touched location. The touch-sensing controller may include an application-specific integrated circuit (ASIC) chip and a digital signal processor (DSP) chip.

In some embodiments, the touch-sensitive screen may provide “single-touch” functionality. In some embodiments, the touch-sensitive screen may provide “multi-touch” functionality. Single-touch functionality may detect input from one user touch on the touch-sensitive screen. For example, the touch-sensitive screen may display a list of payment options and the user may select one or the option by using a finger to touch the desired option. Single-touch functionality may also recognize double finger taps or a long-press functionality.

Multi-touch functionality may detect input from two or more simultaneous user touch points on the touch-sensitive screen. For example, a pinch-to-zoom feature is a multi-touch functionality.

The touch-sensitive screen may include nano-thin light emitting diode (“LED”) technology.

The touch-sensitive screen may include organic light emitting diode (“OLED”) technology. OLEDs are typically solid-state semiconductors constructed from a thin film of organic material. OLEDs emit light when electricity is applied across the thin film of organic material. Because OLEDs are constructed using organic materials, OLEDs may be safely disposed without excessive harm to the environment. Furthermore, OLEDs may be used to construct a display that consumes less power compared to other display technologies.

The touch-sensitive screen display may have a thickness that is not greater than 0.25 mm. The display may be flexible. The display may cover any suitable portion of a card surface. The display may cover an entire card surface.

The smart card may include a haptic response system. The haptic response system may provide a responsive force, vibration or movement in response to receiving a user's touch input. For example, the haptic response system may provide a responsive vibration to a user's touch-based selection of a payment option. The haptic response system may include an eccentric (unbalanced) rotating mass, a linear resonant actuator, a piezoelectric actuator or any other suitable hardware for providing a haptic response.

The microprocessor and associated hardware may interpret finger motions of the user applied to the touch-sensitive screen. For example, the microprocessor may translate the user's finger motions into digital payment information. The microprocessor may translate the user's finger motions into digital payment instructions. The microprocessor may encrypt the captured finger motions.

The microprocessor may formulate a set of payment instructions based on the captured finger motions. The microprocessor may formulate a set of payment instructions based on a user's touch-based selection of payment options displayed on the touch-sensitive screen. The user may provide touch-based confirmation of the accuracy of a payment instruction formulated by the microprocessor.

Illustrative finger motions entered using the touch-sensitive screen and encrypted by the microprocessor may include a personal identification number (“PIN”) associated with the smart card, selection of a payment option, selection of a payment recipient, and entry of a payment percentage or amount.

The touch-sensitive screen may have an inactive state. In the inactive state, the touch-sensitive screen is unable to capture data such as a user's touch inputs. When the touch-sensitive screen is in the inactive state, touch inputs including finger motions applied to the touch-sensitive screen are not captured by the microprocessor.

The touch-sensitive screen may have an active state. In the active state, the touch-sensitive screen is capable of capturing data, such as a user's touch inputs. The inactive state is a default state of the touch-sensitive screen. A default inactive state may avoid the microprocessor capturing inadvertent touch inputs.

The microprocessor may toggle the touch-sensitive screen from the inactive state to the active state. The microprocessor may toggle the touch-sensitive screen from the active state to the inactive state.

The smart card may include a touch-sensitive screen and a virtual keypad. In such embodiments, the housing and the keypad collectively may have a thickness that is not greater than 0.8 mm.

In some embodiments, the smart card may only include a touch-sensitive screen. The touch-sensitive screen may be configured to display a virtual keypad. The virtual keypad may include a display of input buttons that may be touch-selected by the user. In such embodiments, the housing and the touch-sensitive screen collectively may have a thickness that is not greater than 0.8 mm.

The smart card may include executable instructions stored in a non-transitory memory. The executable instructions, when run by the microprocessor may receive an input from another computer system via the wireless interface or input from a user. For example, the input may include a user's touch-based selection of a payment option displayed on a touch-sensitive screen. The input may include an alphanumeric code entered into a virtual keypad. The executable instructions may formulate a set of sensitive payment instructions based on the input.

The formulated sensitive payment instructions may incorporate sensitive transaction information stored on the smart card. Sensitive transaction information, as used herein, may include:
Primary Account Number (“PAN”)
User name
Address
Telephone number
Expiration date
Service code
Authentication data
Personal Identification Number (“PIN”)
PIN Block
Card validation value (CVV), or any other three/four-digit card security code

The PAN is a typically multi-digit number printed on a front face of the smart card. The PAN may identify an issuer bank associated with the smart card. The smart card may correlate the specified issuer to the network address of a secure transaction gateway. The PAN may identify a user account at the issuer bank.

A PIN associated with the smart card may be a secret numeric password known only to the user of the smart card. The PIN may be used to authenticate the user before providing access to a secure payment processing system. A user may only be granted access to the secure system if the PIN provided matches a PIN stored on the secure system. For example, a PIN may be used to authenticate the smart card at an ATM. A PIN may also be used to authorize a digital signature implemented by an EMV chip.

A PIN Block includes data used to encapsulate a PIN during processing and transmission of the PIN. The PIN block defines the location of the PIN within the PIN block and how it can be extracted from the PIN block. A typical PIN block includes the PIN, the PIN length, and may contain subset of the PAN.

A service code may be a multidigit number. For example, in a three-digit service code, the first digit may indicate specific interchange rules that apply to the smart card. The second digit may specify authorization processing that is applied to the smart card when initiating transaction. Illustrative authorization processing may include requiring submission of a PIN, biometric feature, signature or a combination thereof. The second digit may also identify a secure payment gateway that is authorized to process payment instructions formulated by the smart card.

The third digit may specify a range of services that are authorized in connection with use of the smart card. For example, the third digit may indicate whether the smart card may be used at an ATM to withdraw cash or only to purchase goods or services from a merchant.

The smart card may be configured to connect directly to a cloud computing account using the wireless interface.

The smart card may be configured to download contacts comprising a plurality of contact names and associated contact phone numbers from the cloud computing account.

The smart card may display any part of the information downloaded on the touch-sensitive screen. For example, the smart card may display on the touch-sensitive screen a selectable list of contact names received from the cloud computing account. The selectable list may include text, icons or any suitable graphical representations. The smart card may prompt entry of a PIN or other suitable authorization before displaying the information or the selectable list of contact names.

The smart card may receive a user's touch-based selection of a contact name from the plurality of contact names via the touch-sensitive screen.

The smart card may be configured to use the contact phone number associated with the selected contact name to identify a contact bank account and a contact smart card associated with the contact bank account.

The smart card may be configured to transmit instructions to request a payment amount from the contact bank account and the contact smart card.

In some embodiments the smart card may include a phone to bank resolver. The phone to bank resolver may be configured to query financial institutions and smart card issuers to identify a contact bank account and a contact smart card with a contact phone number.

The smart card may be configured to query the user for a payment amount to be requested from the contact smart card. The smart card may receive a payment amount via the touch-sensitive screen. The smart card may be configured to transmit a payment request for the payment amount to the contact smart card.

In some embodiments, the contact smart card may authorize the payment request. The smart card may be configured to receive authorization from the contact smart card for the payment amount. The smart card may be configured to formulate payment instructions based on the contact smart card authorization. The smart card may encrypt the payment instructions. Only the secure payment gateway may be capable of decrypting the payment instructions.

In some embodiments, the smart card may include a reverse payment initiator. The reverse payment initiator may transmit a payment request for a payment amount to a contact bank account and a contact smart card. The contact smart card may authorize the payment request. The reverse payment initiator may determine a network address of a secure payment gateway based on contact smart card authorization. The reverse payment initiator may be configured to transmit payment instructions to complete a transaction for the payment amount to the payment gateway based on the contact smart card authorization.

The smart card may determine an identity of a merchant, an identify of a product/service, and an amount of a payment based on communications received or the user input. The card may formulate payment instructions based on communications received or the input.

Using a wireless interface, the smart card may establish a direct communication channel with a secure payment gateway. A network address of the secure payment gateway may be identified in the sensitive payment instructions formulated by the smart card. The location of the secure payment gateway may be determined based on identity of the contact smart card.

The smart card may transmit payment instructions that include sensitive transaction information directly to the secure payment gateway for processing. In some embodiments, the smart card may transmit the sensitive transaction information to the payment gateway in a separate communication, distinct from transmission of payment instructions. In some embodiments, the smart card may transmit the sensitive transaction information to a first payment gateway and transmit the payment instructions to a second payment gateway. A secure payment gateway may process the payment instructions thereby reducing an exposure risk of the sensitive transaction information.

The secure payment gateway may be operated by an issuer or an acquirer bank. The secure payment gateway may debit an account of the contact smart card for the payment.

The smart card may receive confirmation from the secure payment gateway that the payment instructions have been successfully executed. For example, the secure payment gateway may communicate to the smart card via the wireless interface that the payment instructions generated by the smart card have been successfully executed.

The secure payment gateway may provide the smart card with confirmation that a payment is completed. The confirmation may be displayed on the touch-sensitive screen. In some embodiments, the user may be provided the option to enter additional information using touch-based selection of an option on a touch-sensitive screen or a virtual keypad. The secure payment gateway may trigger the smart card to prompt for the additional information.

In some embodiments, the smart card may receive confirmation directly from a financial institution or a smart card issuer. After successfully processing the payment instructions, the secure payment gateway may push a notification to the financial institution or smart card issuer system confirming successful execution of the payment instructions.

The smart card may include a biometric reader. The microprocessor may require submission of a valid biometric feature before attempting to establish a communication channel with the secure payment gateway. The microprocessor may require submission of a valid biometric feature before submitting the payment instructions to the secure payment gateway.

In some embodiments, the microprocessor may require a touch-based confirmation from the user before transmitting payment instructions to the secure payment gateway. The touch-based confirmation may include the touch-sensitive screen displaying a confirmatory message and requiring the user to register confirmation by touching a target area of the touch-sensitive screen.

In some embodiments, the smart card may include a fingerprint reader embedded within, or underneath the touch-sensitive screen. The user may register confirmation of payment instructions by providing a fingerprint using the embedded fingerprint reader. The microprocessor may confirm whether the provided fingerprint matches a known fingerprint securely stored locally on the smart card. The microprocessor may display the target area associated with a confirmatory message overlaid above the embedded fingerprint reader. By pressing a finger against the target area, the user may register confirmation by touching a target area of the screen and simultaneously submit a fingerprint for verification.

A wireless interface of the smart card may include an inactive state. When in the inactive state, the wireless interface may be unable to connect to a communication channel or transmit data. The wireless interface may include an active state. In the active state, the wireless interface may be capable of connecting to a communication channel, receiving data or transmitting data. The microprocessor may toggle the wireless interface from the inactive state to the active state. The microprocessor may toggle the wireless interface from the active state to the inactive state.

For example, the microprocessor may detect that a valid PIN has been entered by the user of the smart card using the keypad. In response to receiving the valid PIN, the microprocessor may toggle the wireless interface from the inactive to the active state. In response to receiving invalid PIN, the microprocessor may maintain the wireless interface in the inactive state. In some embodiments, if the microprocessor detects a threshold number of invalid PIN entries, the microprocessor may lock the wireless interface.

The microprocessor may require a special code to unlock the wireless interface. The microprocessor may require that the smart card establish a wired connection to unlock the wireless interface. For example, the wireless interface may only be unlocked when the smart card is inserted into a card reader of an ATM. The smart card may also require entry of a valid PIN to access the ATM before unlocking the wireless interface.

The smart card may include a voice controller. The voice controller may generate an audio message confirming the microprocessors interpretation of the user's touch inputs applied to the touch-sensitive screen and captured by the input controller. The microprocessor may prompt the user to touch a target area of the screen to confirm an accuracy of the generated audio message. In response to receiving the user's confirmation, the microprocessor may generate payment instructions for executing the payment identified in the audio message.

The smart card may include a voice controller. The voice controller may generate an audio message confirming a substance of the encrypted payment instructions generated by the smart card. For example, the voice controller may generate an audible message that identifies an amount due.

The voice controller may generate this audible message before payment instructions and any associated sensitive payment information are transmitted to the secure transaction gateway. After the voice controller generates the audible message, the microprocessor may not transmit the encrypted payment instructions to the payment gateway until receiving authorization entered using the touch-sensitive screen. The authorization may be entered by pressing target keys on virtual keypad, or by selecting a selectable option on the touch-sensitive screen to confirm that the user of the smart card wishes to proceed with the transaction.

In some embodiments, the microprocessor may prompt the user to touch a target area of the screen to confirm an accuracy of the generated audio message. In response to receiving the user's confirmation, the microprocessor may generate payment instructions for executing the payment identified in the audio message. In some embodiments, the audio message may itself specify one or more target authorization keystrokes. Illustrative target authorization keystrokes may include pressing two or more keys concurrently or a specified sequence of keys.

A system for requesting a payment from a contact is provided. The system may include a smart card having a thickness not greater than 0.8 mm and a surface area not greater than 86 mm×54 mm. The smart card may include hardware components such as a communication interface and a microprocessor. The smart card may include a user input system in electronic communication with the microprocessor. The user input system may include a touch-sensitive screen and an input controller. The input controller may capture touch inputs entered using the touch-sensitive screen.

The smart card may include a wireless interface. The wireless interface may be configured to communicate using any suitable wireless communication protocol. Exemplary wireless communication protocols may include Wi-Fi, ZigBee, cellular and NFC.

The smart card may include a microprocessor. The microprocessor may be configured to control overall operation of the smart card and its associated components. The smart card may include executable instructions stored in a non-transitory memory. The executable instructions, when run by the microprocessor, may configure the microprocessor to take actions or control operation of one or more components of the smart card.

The executable instructions, when run by the microprocessor may connect directly to a cloud computing account using the wireless interface. The executable instructions may be further configured to download contacts comprising a plurality of contact names and associated contact phone numbers from the cloud computing account.

The executable instructions may be configured to prompt entry of a PIN or other suitable authorization before displaying the communication or downloading the contacts.

The executable instructions may be configured to display on the touch-sensitive screen a selectable list of contact names downloaded from the cloud computing account.

The smart card may be configured to receive a selection of a contact name from the plurality of contact names, via the touch-sensitive screen.

The smart card may be configured to use the contact phone number associated with the selected contact name to identify a contact bank account and a contact smart card associated with the contact bank account.

The smart card may be configured to prompt the user to enter a payment amount. The smart card may be configured to transmit instructions to request the payment amount from the contact bank account and the contact smart card.

The executable instructions, when run by the microprocessor may formulate payment instructions. The microprocessor may encrypt the payment instructions. The microprocessor may formulate transaction instructions based on response to a payment request made to a contact smart card.

The microprocessor may activate a wireless interface of the smart card. The wireless interface may include a NIC. Using the wireless interface, the microprocessor may establish a communication link with a secure payment gateway. A network address of the transaction gateway may be stored on the smart card. For example, the network address of a secure transaction gateway may be stored in firmware of the smart card's NIC.

In other embodiments, the smart card may include a payment interface. The payment interface may determine a network address of a secure payment gateway based on user input via the touch-sensitive screen. The payment interface may determine a network of a secure payment gateway based on communications received via the wireless interface. The payment interface may determine a network of a secure payment gateway based on a selected payment option. The payment interface may resolve different inputs to different payment gateways.

The payment interface may determine an appropriate payment gateway based on the identity of a contact smart card. For example, different contact smart cards may be associated with different acquirer banks. Each of the acquirer banks may utilize different security or communication protocols. The payment interface may direct the smart card to a payment gateway that is compatible with the security or communication protocols utilized by a particular acquirer bank.

The payment interface may determine an appropriate payment gateway based on the amount of a payment. For example, a payment gateway that requires higher level security and authentication may be utilized for larger payments.

In some embodiments the smart card may include a reverse payment initiator. The reverse payment initiator may transmit a payment request for a payment amount to a contact bank account and a contact smart card. The contact smart card may authorize the payment request. The reverse payment initiator may determine a network address of a secure payment gateway based on contact smart card account.

The executable instructions, when run by the microprocessor, may authenticate the smart card to the payment gateway over the secure communication channel. The microprocessor may transmit the encrypted payment instructions to the payment gateway. The payment gateway may then process the payment instructions received from the smart card. Processing payment instructions may include transmitting a payment request to the selected contact smart card.

Processing the payment instructions may include debiting an account of the contact smart card user an amount corresponding to the payment amount. After debiting a contact smart card account, the payment gateway may provide confirmation to the smart card and to the contact smart card.

By interacting with the payment gateway, the system insulates sensitive information from being exposed to potentially unsecure third-party systems. The smart card then securely communicates with a secure payment gateway to process the payment based on the information provided in the user input.

Methods for requesting a payment via a smart card with self-contained transaction architecture are provided. Methods may include, connecting directly to a cloud computing account using the wireless interface.

Methods may include downloading a plurality of contacts, said contacts comprising contact names and associated contact phone numbers from the cloud computing account.

Methods may include querying the user to enter an alphanumeric code via the touch-sensitive screen prior to transmitting the contact name and contact phone number.

Methods may include receiving via the touch-sensitive screen the alphanumeric code.

Methods may include verifying that the alphanumeric code is associated with the user and the cloud computing account.

Methods may include displaying on the touch-sensitive screen a selectable list of contact names received from the cloud computing account.

Methods may include receiving a selection of a contact name, said name selected from the plurality of contact names, via the touch-sensitive screen.

Methods may include using the contact phone number associated with the selected contact name to identify a contact bank account and a contact smart card associated with the contact bank account.

Methods may include transmitting instructions to request funds from the contact smart card.

Methods may include generating payment instructions. The payment instructions may integrate sensitive transaction information stored locally on the smart card. Methods may include determining a network address of a secure payment gateway. Using a wireless interface of the smart card, methods may include establishing a secure communication channel with the secure payment gateway.

Methods may include transferring the transaction instructions to the secure payment gateway using the secure communication channel. The secure payment gateway may provide a secure interface, operated by an issuer of the smart card, for insulating the sensitive transaction information stored on the smart card from direct interaction with the contact smart card system. Because the sensitive transaction information is transmitted directly to the secure payment gateway, the sensitive transaction information is not exposed to any other third party-systems.

Methods may include capturing payment information using a touch-sensitive screen embedded in a smart card. The touch-sensitive screen may display a list of selectable contact names that may be selected by a user. The user may touch the one or more of the displayed contact names.

Based on the contact name touched (e.g., selected) by the user, the microprocessor may query financial institutions and smart card issuers for a contact bank account and a contact smart card associated with a contact phone number.

In some embodiments, the method may include using a phone to bank resolver. The phone to bank resolver may be configured to query financial institutions and smart card issuers for a contact bank account and a contact smart card associated with a contact phone number.

In some embodiments, the method may include using a reverse payment initiator. The reverse payment initiator may be configured to send a payment request to a contact smart card. The contact smart card may accept the payment request. The reverse payment initiator may transmit payment instructions to the payment gateway.

In some embodiments, the method may include using a payment interface. The payment interface may be configured to resolve selection of a contact smart card or a payment to a known secure smart card issuer system. The payment interface may determine whether the smart card issuer system is a system that meets security requirements set by the issuer of the smart card. The secure contact smart card system may securely process the payment instructions formulated by the smart card.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

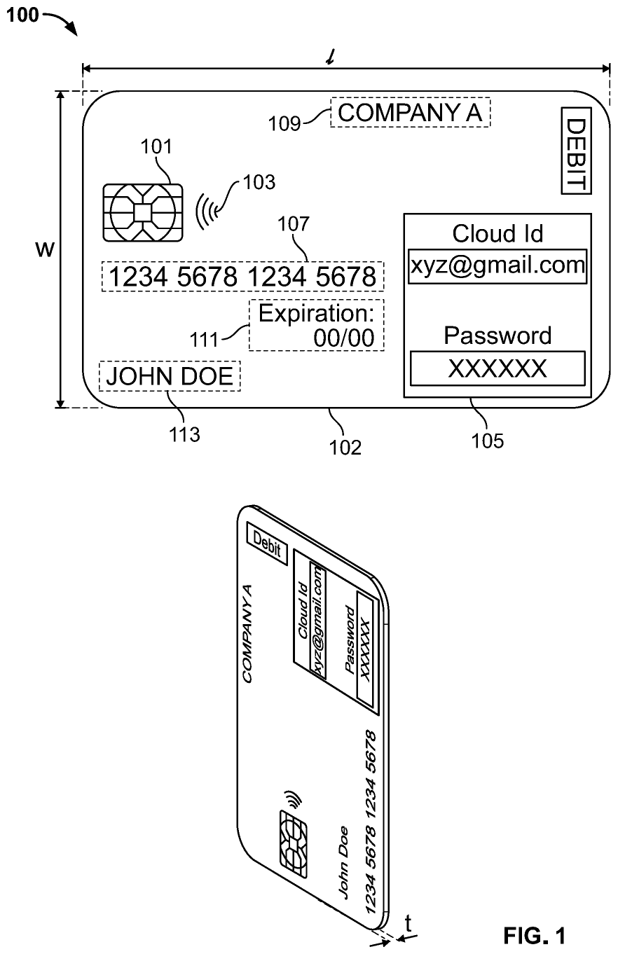

FIG. 1 shows an exemplary smart card, illustrative smart card 100. Smart card 100 includes touch-sensitive screen 105. Touch-sensitive screen 105 may be used by a user of smart card 100 to enter information.

Smart card 100 includes a microprocessor and other components for capturing, encrypting and storing information entered by a user. Smart card 100 may also include executable instructions for packaging information entered via touch-sensitive screen 105 into payment instructions that may be executed by a secure payment gateway. The executable instructions may also formulate the payment instructions based on sensitive payment information stored on the smart card.

FIG. 1 shows that smart card 100 includes chip 101. Chip 101 may provide an electrical contact that is accessible through housing 102. Chip 101 may provide an electrical contact for establishing a wired or contact based communication channel with an ATM or POS terminal when card 100 is inserted into a card reader of the ATM or POS terminal. Chip 101 may be an EMV chip.

Chip 101 may store a copy of information printed on a face of smart card 100. For example, chip 101 may store PAN 107, user name 113, expiration date 111 and issuing bank 109. Chip 101 may also store encrypted security information. The encrypted security information may be utilized to provide a “second factor” method of authentication prior to triggering execution of payment instructions.

For example, smart card 100 may package information entered by a user via touch-sensitive 105 into payment instructions. The payment instructions may include a PIN associated with smart card 100. The payment instructions may be submitted for execution to a payment gateway without requiring any further input from a user. The payment instructions may be transferred to the payment gateway using wireless circuitry 103.

After a payment gateway receives transaction instructions formulated by smart card 100, the payment gateway may first verify that the PIN included in the payment instructions is associated with smart card 100. For example, the payment gateway may communicate with a remote payment processing server operated by the issuer and determine whether the received PIN is associated with user name 113 and/or PAN 107.

As a second factor method of authentication, the payment gateway may determine whether the PIN included in the payment instructions successfully unlocks encrypted security information stored on chip 101. If the PIN successfully unlocks the encrypted security information, the payment gateway may execute the received payment instructions.

Smart card 100 may be any suitable size. FIG. 1 shows that smart card 100 has width w and length 1. For example, width w may be 53.98 millimeters (“mm”). Length 1 may be 85.60 mm. Smart card 100 has thickness t. An illustrative thickness t may be 0.8 mm. An exemplary form factor of smart card 100 may be 53.98 mm×85.60 mm×0.8 mm. Such an exemplary form factor may allow smart card 100 to conveniently fit into a user's wallet or pocket. This exemplary form factor may allow smart card 100 to fit into a card reader of an ATM or POS terminal.

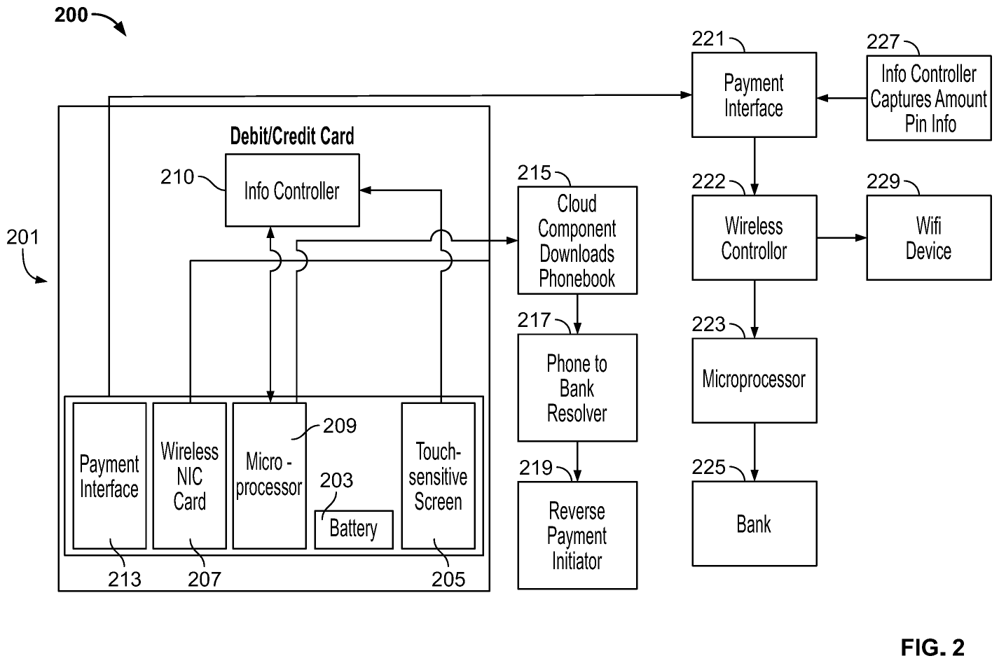

FIG. 2 shows exemplary system architecture 200 according to aspects of the disclosure. Smart card 201 communicates with cloud application 215 to request payment from a contact smart card in accordance with the principles of the disclosure. Smart payment card 201 may have one or more features in common with smart payment card 100. In some embodiments, the smart card 201 may include a payment interface 213, a microprocessor 209, a network interface card (“NIC”) 207, a battery 203, a touch-sensitive screen 205, along with non-transitory memory and antennae (not shown), among other components. The NIC 207 may enable the smart card 201 to connect to a wi-fi device 229 through a wireless controller 222. In some embodiments, the wi-fi network may be a cellular network, or a LAN such as Bluetooth.

Through the wireless controller 222 and microprocessor 209, the smart card 201 may communicate with a cloud component 215 and download contacts comprising a plurality of contact names and associated contact phone numbers from the cloud computing account. The contact names and contact phone numbers may be streamed to the smart payment card 201 instead of downloaded in full. The microprocessor 209 may then display a selectable list of contact names on the touch-sensitive screen 205. The user, through touch-sensitive screen 205, may select a contact name to request a payment. The user may insert a payment amount through touch-sensitive screen 205.

The cloud-component 215 may communicate with phone to bank resolver 217. Phone to bank resolver 217 may query financial institutions and smart card issuers to associate a contact phone number with a contact bank account and a contact smart card. Phone to bank resolver 217 may associate the contact's bank 225 information through the cloud-component 215 (e.g., when the recipient is entered into the contact list, its bank information is entered as well), through a proprietary and confidential database, through the contact's phone number, or through any other appropriate method.

After the contact phone number is associated with a contact bank account and a contact smart card, reverse payment initiator 219 transmits a payment request to the contact smart card's bank 225. The contact smart card bank then transmits the payment request to the contact smart card (not shown). In some embodiments the contact smart card authorizes the payment request. The reverse payment initiator may send payment instructions to the contact's bank to complete the transaction. The contact's bank 225 may then follow its own protocols in disbursing the payment to the recipient.

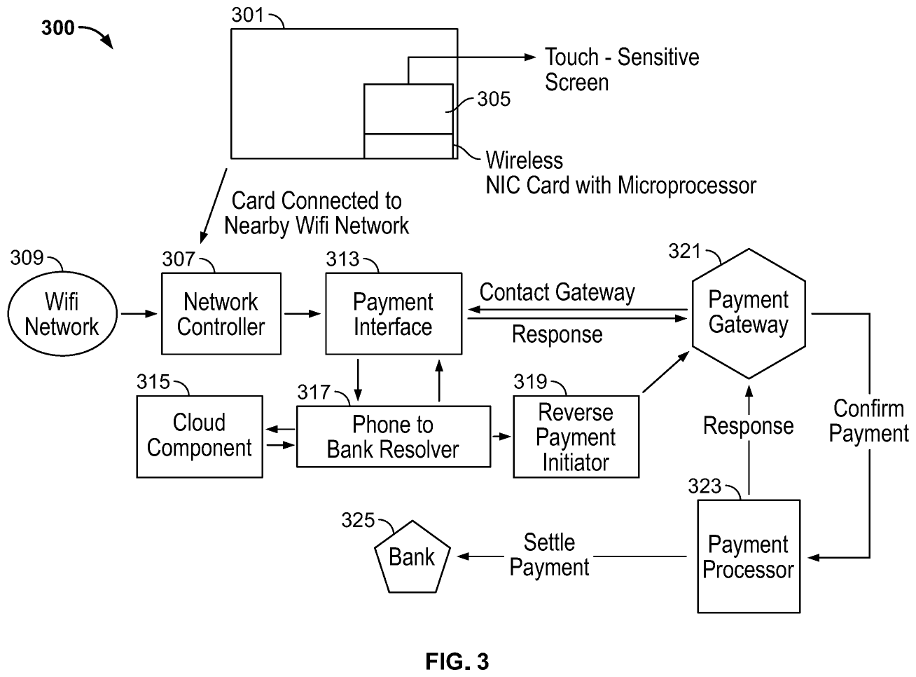

FIG. 3 shows another exemplary system architecture including smart card 301 according to aspects of the disclosure. Smart card 301 may include one or more features of smart cards 100 or 201. Smart card 301 may include a touch-sensitive screen 305, a microprocessor, a network interface card, along with a battery, non-transitory memory, and antennae (not shown), among other components. The NIC may enable the smart payment card 301 to connect to a wi-fi network 309 through a network controller 307. In some embodiments, the wi-fi network may be a cellular network, or a LAN such as Bluetooth.

After connecting to a wi-fi network 309 through a network controller 307 and NIC, the smart payment card 301 may access a cloud component 315. The cloud component 315 may download contacts comprising a plurality of contact names and associated contact phone numbers from the cloud component 315. The information retrieved from the cloud component 315 may be displayed on touch-sensitive screen 305. The user may be prompted to select a contact name from the plurality of contact names displayed. The smart card receives the selection of a contact name through the touch-sensitive screen 305. Further, the user may be prompted to enter a payment amount. The phone to bank resolver 317 transmits queries to financial institutions and smart card issuers to associate a contact bank account and contact smart card with the contact phone number. The phone to bank resolver 317 may be able to determine the contact's financial institution information so that the user's may request a payment. The reverse payment initiator 319 transmits the payment request to the contact's bank 325. The contact bank transmits the request to the contact smart card. The contact smart card displays the request on the contact smart card touch sensitive screen. In some embodiments the contact smart card accepts the request. Then the reverse payment initiator 319 communicates with the payment gate 321 and the payment processor 323 to complete the payment transaction.

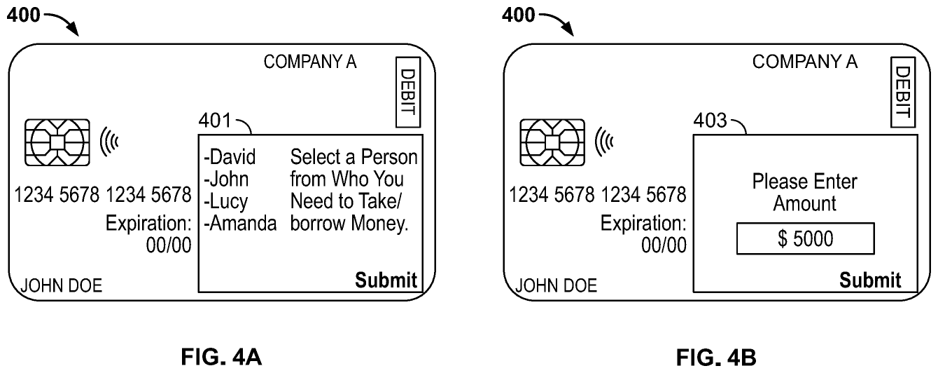

FIG. 4A-4B shows views of another exemplary smart card, illustrative smart card 400. Smart card 400 may include one or more of the features of smart card 100, 201, and 301.

Smart card 400 includes touch-sensitive screen 401. Touch-sensitive screen 401 may include one or more of the features of touch-sensitive screen 105, 205 and 305. Touch-sensitive screen 401 may be used by a user of smart card 400 to enter information. Exemplary information may include a selectable contact name. In FIG. 4A touch-sensitive screen 401 is displaying a selectable lists of contact names that have been downloaded from the cloud component.

In some embodiments, the user may be prompted to enter a payment amount. FIG. 4B shows the user being prompted to enter a payment amount on the touch-sensitive screen 403.

Smart card 400 may establish a direct communication channel with a secure payment gateway. The location of the secure payment gateway may be determined based on a contact phone number. Smart card 400 will then communicate with the secure payment gateway so a payment request is sent to a contact smart card 405.

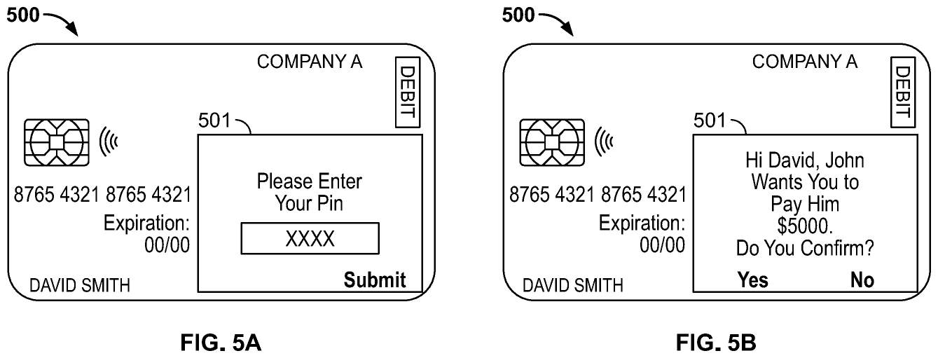

FIG. 5A-5B shows views of the contact smart card 500. Smart card 500 may include one or more of the features of smart card 100, 201, and 400.

Smart card 500 includes touch-sensitive screen 501. Touch-sensitive screen 501 may include one or more of the features of touch-sensitive screen 105, 205, and 401. Touch-sensitive screen 501 is displaying a payment request for the contact smart card to authorize a payment amount requested by smart card 400.

FIG. 5B shows views of contact's smart card 400 prompting the user to enter a pin to complete the authorization for the payment amount.

Thus, systems, methods, and apparatus for SMART CARD WITH REVERSE PAYMENT TECHNOLOGY are provided. Persons skilled in the art will appreciate that the present invention can be practiced by other than the described embodiments, which are presented for purposes of illustration rather than of limitation, and that the present invention is limited only by the claims that follow.

What is claimed is:

1. A smart card with self-contained transaction architecture for requesting a payment, the smart card comprising:
a microprocessor;
a touch-sensitive screen;
a power source for providing power to the microprocessor and the touch-sensitive screen;
a wireless interface configured to provide wireless communication;
a non-transitory memory storing computer-executable instructions, that, when run on the microprocessor:
connect to a cloud computing account using the wireless interface;
download one or more contact names and associated contact phone numbers from the cloud computing account;
display on the touch-sensitive screen a selectable list of contact names downloaded from the cloud computing account;
receive a selection of a contact name via the touch-sensitive screen;
use a contact phone number associated with the selected contact name to identify a contact bank account and a contact smart card associated with the contact bank account; and
transmit instructions to the contact bank account and contact smart card to request a payment amount.

2. The smart card of claim 1 wherein the computer-executable instructions are further configured to:
prompt the user to enter an alphanumeric code via the touch-sensitive screen before downloading the contact names and contact phone numbers;
receive entry of the alphanumeric code via the touch-sensitive screen the alphanumeric code; and
verify that the alphanumeric code is associated with the user and the cloud computing account.

3. The smart card of claim 1 wherein the computer executable instructions are further configured to:
prompt the user to enter a payment amount via the touch-sensitive screen; and
receive entry of the payment amount via the touch-sensitive screen.

4. The smart card of claim 1 wherein the smart card receives authorization for the payment amount from the contact smart card, the computer-executable instructions, when run by the microprocessor:
determine a network address of a payment gateway, the determination based on the contact bank account associated with the contact smart card; and
transmit payment instructions to the payment gateway to execute a payment for the payment amount.

5. The smart card of claim 1 wherein the smart card is made of metal and/or plastic.

6. The smart card of claim 1 wherein the smart card has dimensions that conform to the ISO/IEC 7810 ID-1 standard.

7. The smart card of claim 1, wherein the smart card has the dimensions being no greater than 86 millimeters×54 millimeters×0.8 millimeters.

8. The smart card of claim 1, wherein:
the wireless interface is a nano wireless network interface card (“NIC”);
the power source is rechargeable via solar energy, inductive charging, and/or a charging port; and
the microprocessor, the power source, the wireless interface, and the memory are embedded in the card.

9. A system for requesting a payment from a contact, the system comprising a smart card with self-contained transaction architecture, wherein the smart card is metal and/or plastic and comprises dimensions that conform to the ISO/IEC 7810 ID-1 standard, said dimensions being no greater than 86 millimeters×54 millimeters×0.8 millimeters, the system comprising:
a microprocessor embedded in the smart card;
a touch-sensitive screen that is affixed to the smart card and exposed on a surface of the smart card;
a power source for the microprocessor and the touch-sensitive screen, the power source that is embedded in the smart card and is rechargeable via solar energy, inductive charging, and/or a charging port;
a wireless interface configured to provide wireless communication, wherein the wireless interface is a nano wireless network interface card (“NIC”) that is embedded in the smart card; and
a non-transitory memory embedded in the smart card and storing computer-executable instructions, that, when run on the microprocessor, are configured to:
connect to a cloud computing account using the wireless interface;
download one or more contact names and associated contact phone numbers from the cloud computing account;
display on the touch-sensitive screen a selectable list of contact names downloaded from the cloud computing account;
receive a selection of a contact name via the touch-sensitive screen;
use a contact phone number associated with the selected contact name to identify a contact bank account and a contact smart card associated with the contact bank account; and
transmit instructions to the contact bank account and contact smart card to request a payment amount.

10. The system of claim 9 wherein the computer-executable instructions are further configured to:
prompt the user to enter an alphanumeric code via the touch-sensitive screen before downloading the contact names and contact phone numbers;
receive entry of the alphanumeric code via the touch-sensitive screen the alphanumeric code; and
verify that the alphanumeric code is associated with the user and the cloud computing account.

11. The system of claim 9 wherein the computer-executable instructions are further configured to:
prompt the user to enter a payment amount via the touch-sensitive screen; and
receive entry of the payment amount via the touch-sensitive screen.

12. The system of claim 9 wherein the smart card receives authorization for the payment amount from the contact smart card, the computer-executable instructions, when run by the microprocessor:
determine a network address of a payment gateway, the determination based on the contact bank account associated with the contact smart card; and
transmit payment instructions to the payment gateway to execute a payment for the payment amount.

13. The system of claim 9, wherein:
the wireless interface is a nano wireless network interface card (“NIC”);
the power source is rechargeable via solar energy, inductive charging, and/or a charging port; and
the microprocessor, the power source, the wireless interface, and the memory are embedded in the card.

14. A method for requesting a payment via a smart card with self-contained transaction architecture, the method executed via computer-executable instructions that are stored in a non-transitory memory of the smart card and run on a microprocessor embedded in the smart card, the method comprising:
connecting to a cloud computing account using the wireless interface;
downloading a plurality of contacts, said contacts comprising contact names and associated contact phone numbers from the cloud computing account;
displaying on the touch-sensitive screen a selectable list of contact names downloaded from the cloud computing account;
receiving a selection of a contact name via the touch-sensitive screen;
using a contact phone number associated with the selected contact name to identify a contact bank account and a contact smart card associated with the contact bank account; and
transmitting instructions to the contact bank account and contact smart card to request a payment amount.

15. The method of claim 14 wherein the computer-executable instructions when run on a microprocessor connect to a cloud computing account, the method further comprising:
querying the user to enter an alphanumeric code via the touch-sensitive screen prior to downloading the contact names and contact phone numbers;
receiving entry of the alphanumeric code via the touch-sensitive screen the alphanumeric code; and
verifying that the alphanumeric code is associated with the user and the cloud computing account.

16. The method of claim 14 wherein the computer-executable instructions when run on a microprocessor transmit instructions to request funds from the contact smart card, the method further comprising:
prompting the user to enter a payment amount via the touch-sensitive screen; and
receiving the payment amount via the touch-sensitive screen.

17. The method of claim 14 wherein the smart card receives authorization for the payment amount from the contact smart card the method further comprises:
determining a network address of a payment gateway, the determination based on contact bank account associated with the contact smart card; and
transmitting payment instructions to the payment gateway to execute a payment for the payment amount.
